(19) United States
(12) Patent Application Publication
(10) Pub. No.: US 2010/0009050 A1
(43) Pub. Date: Jan. 14, 2010

(54) OMELET IN A PITA POCKET BREAD

(76) Inventor: George Kashou, Mequon, WI (US)

Correspondence Address: QUARLES & BRADY LLP, 411 E. WISCONSIN AVENUE, SUITE 2040, MILWAUKEE, WI, 53202-4497, US

(21) Appl. No.: 12/172,356

(22) Filed: Jul. 14, 2008

(51) Int. Cl. A23L 1/32

(52) U.S. Cl. 426/282; 426/614

(57) ABSTRACT

A food product is prepared by mixing at least one egg and cheese with other ingredients, such as bell pepper, chili pepper, onion, mushroom, and meat, to form an omelet mixture. The omelet mixture is cooked to produce an omelet that preferably is formed into a generally semicircular shape. The formed omelet then is frozen. A round piece of pita pocket bread is prepared and baked using a conventional recipe. Then the baked pita pocket bread is cut in half diametrically and opened. The frozen omelet is inserted into the into the opened pita pocket bread and the combination is frozen. Freezing the omelet prior to insertion into the unfrozen opened pita pocket bread facilitates that insertion.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to pocket bread, such a pita pocket bread, and more particularly to pita pocket bread that contains an omelet.

2. Description of the Related Art

Pita and pita pocket bread are names used to refer to two types of bread, each possessing its own distinguishing characteristics and functionality. A pita is a flat bread that is served with toppings or condiments placed on top of the bread and the bread is either laid flat or folded over. Although pita pocket bread has a similar round, flat shape, this bread is formed with two layers. A pita pocket bread typically is cut in half diametrically and the layers separated to expose a pocket that then is filled other food items, such as meat, cheese, salad ingredients, other vegetables, and the like. Whereas the contents of a folded pita bread may spill out the open sides, the pocket configuration of the pita pocket bread holds in the food filling.

However, stuffing an open pita pocket bread requires skill as the material must be carefully inserted in between the two layers of bread so that the bread is not torn. If several individual food items are to be stuffed into the pocket, care must be taken that each one is spread out evenly across the entire pocket. Otherwise the person eating the stuffed pocket may encounter large areas of only one food item, whereas it is desirable that each bite collects a mixture of all the pocket contents.

Various types of breakfast sandwiches are commercially available, either fresh at restaurants or frozen for home consumption. Such sandwiches usually are formed between halves of a biscuit or an English muffin. The contents of the sandwich may comprise a scrambled or poached egg with a slice of cheese and a layer of meat, such as a sausage patty, ham, or bacon. The individual contents of the sandwich are layered on one half of the biscuit or English muffin and the other half is then placed on top of the assembled product to form the sandwich.

Omelets are well known as another breakfast item in which meat and different vegetables, such as bell peppers and onions are scrambled together with an egg. That mixture then is fried and shortly before the end of cooking, a slice of cheese is placed on top of the mixture and allowed to melt. The omelet is often served on a plate with a side item of meat, such as a slice of ham, slices of bacon, or a sausage patty or links.

The present inventor desires to mass produce a frozen breakfast product comprising pita pocket bread filled with an omelet for sale at grocery stores. However, difficulty was encountered when attempting to insert separately an egg omelet, a slice of cheese, and a piece of meat into an opened pita pocket. Care had to be taken to properly arrange each of those individual food items so that they were distributed across the entire pocket without tearing the bread. As a result the assembly did not lend itself to easy mass production. In particular the very soft, pliable characteristic of an omelet made that item difficult to insert.

As a consequence, an alternative process for assembling the breakfast product is required that facilitates mass production.

### SUMMARY OF THE INVENTION

A pita pocket bread containing an omelet is prepared by mixing at least one egg and cheese to form an omelet mixture. Other optional ingredients, such as bell pepper, chili pepper, onion, mushroom, and meat also may be added to the omelet mixture. The omelet mixture is cooked to form an omelet. Preferably, either during or after cooking, the omelet mixture is formed into a generally semicircular shape. The formed omelet then is frozen.

A piece of pita pocket bread is prepared and baked using a conventional recipe. Then the baked pita pocket bread is opened. For example, a round piece of baked pita pocket bread is cut is half diametrically to form two semicircular pieces and layers of one semicircular piece are spread apart to open the pocket. The frozen omelet is inserted into the opened pocket. Then the combination of the pita pocket bread with the frozen omelet inserted therein is frozen.

Freezing the omelet prior to insertion into the unfrozen opened pita pocket bread facilitates that assembly process. Specifically, the omelet becomes rigid upon freezing, thus handling and insertion into the bread pocket are easier than with an unfrozen omelet.

### BRIEF DESCRIPTION OF THE DRAWINGS

FIG. 1 illustrates an omelet adjacent to a piece of opened pita pocket bread; and

FIG. 2 shows the piece of pita pocket bread stuffed with the omelet.

### DETAILED DESCRIPTION OF THE INVENTION

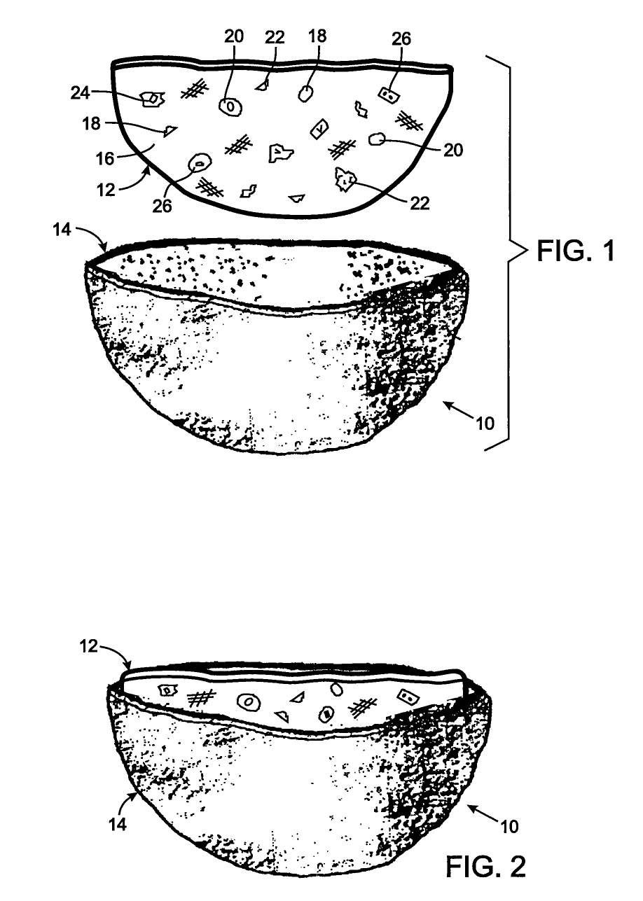

With initial reference to FIG. 1, a food product 10 comprises an omelet 12 and a piece of pita pocket bread 14. The omelet 12 is prepared by scrambling an egg with seasonings and placing it into a frying pan along with pieces of cheese. In addition, one or more vegetables, such as onions, bell peppers, and chili peppers, and pieces of meat, such as ham, bacon, or sausage, optionally may placed into the egg and cheese mixture. Other ingredients, such as mushrooms for example, may be added. This mixture is then fried until the egg becomes solid entrapping the other food items.

The resultant omelet has a generally semicircular shape conforming to the pocket of half a conventional pita pocket bread. This shape is achieved either by utilizing a specially shaped frying pan, or by a folding a circular omelet shortly before or after removal from the pan. This procedure forms an omelet 12 as shown in FIG. 1, that comprises an egg 16 in which pieces of cheese 18, onion 20, bell peppers 22, mushrooms 24, and meat 26 are contained. It should be understood that variations of this omelet can be prepared with less than all of these ingredients.

After the omelet has been properly cooked and formed, it is flash frozen thereby becoming very rigid and no longer pliable.

The pita pocket bread 14 is made according to any suitable recipe and baking method. For example, pita bread dough is mixed and cut into a three ounce disc-shaped circular portion. Alternatively, the dough can be extruded into a large flat sheet approximately ¼ inch thick, and then a die cutting roller is used to divide dough into discs, typically approximately six inches in diameter, from the sheet of dough. Either way, the formed portion of dough may be placed on a conveyor where it travels into a proof chamber to rise in preparation for baking. Baking is accomplished in a tunnel oven operating at a temperature of about 750° F., through which the dough travels for approximately one minute. As a result of the intense heat, quick bake time, and thickness of the dough, the bread exits the oven inflated, almost like a soccer ball, thereby creating a pocket between two outer layers of bread. This is a result of steam buildup within the pocket. As the bread cools, the steam is released and the walls of the pocket collapse into a circular, flat pita pocket bread with no visible cavity.

After cooling, the circular, flat pita pocket bread is cut in half forming two semicircular pieces, one of which is shown as 14 in FIG. 1. The piece of pita pocket bread 14 is allowed to cool sufficiently so that it will not partially thaw the frozen omelet 12. Then layers of the pita pocket bread are spread apart to open the pocket into which the frozen omelet 12 is inserted, forming a combined food product 10, as shown in FIG. 2. Because the vegetables, meat, and cheese are all integrated with the eggs into the omelet, the combined frozen item can be easily inserted into the open pocket in one motion. Furthermore, because the omelet combination is rigid because it is frozen, insertion into the opened pita pocket bread 14 is easily accomplished in a mass production environment.

This food product is then suitably packaged, such as in a sealed plastic bag. The packaged pita pocket bread, stuffed with an omelet, is then flash frozen so that the bread also becomes frozen. Thereafter one or more of the individually packaged food products 10 are placed into boxes for storage and shipment.

The combined food product 10 is maintained in a frozen state until a person desires to prepare it for consumption. At that time, the pita pocket bread 14 that is stuffed with an omelet 12 is removed from the packaging, placed in a microwave or conventional oven, and heated to the desired serving temperature. The food product 10, however, does not have to be cooked further.

The foregoing description was primarily directed to a preferred embodiment of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. A method for preparing pita pocket bread containing an omelet comprising:
mixing at least one egg and cheese to form an omelet mixture;
cooking the omelet mixture to form an omelet;
freezing the omelet, thereby forming a frozen omelet;
baking a piece of pita pocket bread;
opening the piece of pita pocket bread;
inserting the frozen omelet into the pita pocket bread; and
freezing the pita pocket bread with the frozen omelet inserted therein.

2. The method as recited in claim 1 further comprising, either during or after cooking, forming the omelet into a generally semicircular shape.

3. The method as recited in claim 1 wherein opening the piece of pita pocket bread comprises cutting pita pocket bread to form a generally semicircular piece of pita pocket bread; and thereafter spreading apart two layers of the piece of pita pocket bread.

4. The method as recited in claim 1 further comprising placing the frozen the pita pocket bread with the frozen omelet inserted therein into a plastic enclosure.

5. The method as recited in claim 1 wherein the mixing further comprises adding pieces of at least one vegetable to the omelet mixture.

6. The method as recited in claim 5 wherein the mixing comprises mixing pieces of a bell pepper to the omelet mixture.

7. The method as recited in claim 5 wherein the mixing comprises mixing pieces of an onion to the omelet mixture.

8. The method as recited in claim 1 wherein the mixing further comprises adding meat to the omelet mixture.

9. The method as recited in claim 8 wherein the mixing comprises adding pieces of ham to the omelet mixture.

10. The method as recited in claim 8 wherein the mixing comprises adding pieces of sausage to the omelet mixture.

11. The method as recited in claim 8 wherein the mixing comprises adding bacon to the omelet mixture.

12. The method as recited in claim 1 wherein the mixing further comprises adding pieces of mushroom into the omelet mixture.

13. A method for preparing a pita pocket bread containing an omelet comprising:
mixing at least one egg, cheese, meat, and at least one of a vegetable to form an omelet mixture;
cooking the omelet mixture;
either during or after cooking, forming the omelet mixture into a generally semicircular shape to form an omelet;
freezing the omelet thereby forming a frozen omelet;
baking a piece of pita pocket bread;
opening a pocket of the piece of pita pocket bread in an unfrozen state;
inserting the frozen omelet into the pocket; and
freezing the pita pocket bread with the frozen omelet inserted therein.

14. The method as recited in claim 12 further comprising placing the frozen the pita pocket bread with the frozen omelet inserted therein into a plastic enclosure.

15. The method as recited in claim 13 wherein opening the piece of pita pocket bread comprises cutting pita pocket bread to form a generally semicircular piece of pita pocket bread; and thereafter spreading apart two layers of the piece of pita pocket bread

16. The method as recited in claim 13 wherein the mixing comprises adding pieces of a bell pepper and pieces of an onion to the omelet mixture.

17. The method as recited in claim 13 wherein the mixing comprises adding pieces of ham into the omelet mixture.

18. The method as recited in claim 13 wherein the mixing comprises adding pieces of sausage into the omelet mixture.

19. The method as recited in claim 13 wherein the mixing comprises adding bacon into the omelet mixture.

20. The method as recited in claim 13 wherein the mixing further comprises adding pieces of mushroom into the omelet mixture.
